(19) United States
(12) Patent Application Publication
(10) Pub. No.: US 2025/0354533 A1
(43) Pub. Date: Nov. 20, 2025

(54) IGNITION COIL AND IGNITION DEVICE

(71) Applicant: DIAMOND&ZEBRA ELECTRIC MFG.CO.,LTD., Osaka (JP)

(72) Inventors: Takaaki MIURA, Osaka (JP); Takushi NISHIMURA, Osaka (JP); Yukitoshi YAMAGISHI, Osaka (JP); Hiroyuki KIMURA, Osaka (JP)

(21) Appl. No.: 19/202,510

(22) Filed: May 8, 2025

(30) Foreign Application Priority Data
May 16, 2024 (JP) 2024-079877

(51) Int. Cl. F02P 3/04; F02P 9/00; F02P 15/10; H01F 38/12

(52) U.S. Cl. CPC F02P 3/0407; F02P 9/002; F02P 15/10; H01F 38/12

(57) ABSTRACT

In first and second primary coils, a direct-current voltage is applied to one end, and the other end is grounded. A first iron core passes through the first primary coil and a first secondary coil. A second iron core passes through the second primary coil and a second secondary coil. One ends, as well as the other ends, of the iron cores are connected, to form a closed magnetic circuit. When a direct-current voltage is applied to the first primary coil, a magnetic flux from the other end to the one end is generated in the first iron core. When a direct-current voltage is applied to the second primary coil, a magnetic flux from the other end to the one end is generated in the second iron core. This enables miniaturization and energy enhancement of an ignition coil for an internal combustion engine to which DCO ignition is applicable.

### RELATED APPLICATIONS

This application claims the benefit of Japanese Application No. 2024-079877, filed on May 16, 2024, the disclosure of which is incorporated by reference herein.

### BACKGROUND OF THE INVENTION

### Field of the Invention

The present disclosure relates to an ignition coil for use in an internal combustion engine and an ignition device including the ignition coil.

### Description of the Background Art

Conventionally, in an internal combustion engine of an automobile or the like, in order to improve fuel efficiency as a countermeasure against exhaustion of resources, lean combustion is performed in which a lean fuel having a fuel ratio lower than the theoretical air-fuel ratio is burned, in some cases. Meanwhile, in order to realize a decarbonized society as a countermeasure against global warming, use of ammonia containing no carbon as a fuel is under consideration. However, those fuels are typically more flame-retardant than gasoline, and high energy is required for ignition thereof. Then, in order to effectively burn those fuels, there are various ignition methods under consideration, such as a multiple ignition method in which discharge is caused to successively occur a plurality of times in a spark plug, or a dual coil offset (DCO) ignition method in which discharge is caused to continuously occur in a spark plug for a certain period of time close to an ignition timing. For example, in Japanese Patent Gazette No. 6005943, an ignition system for use in an internal combustion engine in which the DCO ignition method is adopted is disclosed.

An ignition device for use in an internal combustion engine according to Japanese Patent Gazette No. 6005943 includes ignition coils Ca and Cb, igniters IGTa and IGTb, and a case body (10) in which the coils and the igniters are stored (paragraph [0021], FIGS. 1 and 2). The ignition coil Ca includes a primary coil La1, a secondary coil La2, and an iron core Ma, and the ignition coil Cb has a similar configuration (paragraph [0022]). Further, the secondary coils La2 and Lb2 of the ignition coils Ca and Cb are connected to one common spark plug PG. Then, upon receipt of an ignition signal, the ignition device steps up a bias voltage Vout of a DC-DC converter and applies the stepped-up voltage to the spark plug PG. Thus, high voltages from both the ignition coils Ca and Cb are applied to the spark plug PG (paragraphs [0025] and [0027]).

However, in a case in which a closed magnetic circuit of an iron core is formed in each of the two ignition coils Ca and Cb as in Japanese Patent Gazette No. 6005943, there is a problem of an increase in size of the entire device. In view of this, in order to miniaturize the entire device and facilitate mounting of the device in an internal combustion engine, the structures of the ignition coils and the iron core are susceptible to improvement.

### SUMMARY OF THE INVENTION

It is an object of the present disclosure to provide a technology that can improve a structure of an ignition coil for use in an internal combustion engine to which the DCO ignition method is applicable, and further miniaturize the entire device.

In order to solve the above-described problem, the first invention of the present application is directed to an ignition coil for use in an internal combustion engine, including a first primary coil, a first secondary coil, a first iron core, a second primary coil, a second secondary coil, and a second iron core. The first primary coil includes a first primary winding, in which a direct-current voltage is applied to a first end and a second end is connected to a ground point. The first secondary coil includes a first secondary winding. The first iron core passes through an inside of the first primary coil and an inside of the first secondary coil and is configured to electromagnetically couple the first primary coil and the first secondary coil. The second primary coil includes a second primary winding, in which the direct-current voltage is applied to a first end and a second end is connected to the ground point. The second secondary coil includes a second secondary winding. The second iron core passes through an inside of the second primary coil and an inside of the second secondary coil and is configured to electromagnetically couple the second primary coil and the second secondary coil. One end of the first iron core and one end of the second iron core are connected to each other, and the other end of the first iron core and the other end of the second iron core are connected to each other, to form a closed magnetic circuit. A magnetic flux directed from the other end to the one end is generated in the first iron core when the direct-current voltage is applied to the first primary coil. A magnetic flux directed from the other end to the one end is generated in the second iron core when the direct-current voltage is applied to the second primary coil.

The second invention of the present application is directed to an ignition device including the ignition coil of the first invention, a power supply device, a first switching element, a second switching element, a first control unit, a second control unit, and a spark plug. The power supply device is configured to apply the direct-current voltage to each of the first end of the first primary coil and the first end of the second primary coil. The first switching element is interposed between the second end of the first primary coil and the ground point and is configured to perform switching between passage and interruption of a first primary current flowing from the power supply device to the first primary coil. The second switching element is interposed between the second end of the second primary coil and the ground point and is configured to perform switching between passage and interruption of a second primary current flowing from the power supply device to the second primary coil. The first control unit is configured to control the switching of the first switching element. The second control unit is configured to control the switching of the second switching element. The spark plug is configured to ignite a fuel by occurrence of discharge at a gap, in accordance with a high voltage induced at a second end of the first secondary coil and/or a high voltage induced at a second end of the second secondary coil.

The third invention of the present application is directed to the ignition device of the second invention, wherein the first control unit performs primary energization control, discharge control, and boost control. In the primary energization control, the first switching element is placed in a closed state, and the first primary current is caused to flow through the first primary coil, to generate magnetomotive force. In the discharge control, after the primary energization control, the first switching element is placed in an open state, and a high voltage is induced at the second end of the first secondary coil, to cause discharge to occur at the gap of the spark plug. Further, the second control unit performs boost control and discharge control, In the boost control performed by the second control unit, the second switching element is placed in a closed state, and the second primary current is caused to flow through the second primary coil, to amplify the magnetic flux generated in the closed magnetic circuit when the first control unit performs the discharge control. By performing the boost control, the second control unit performs also primary energization control in which the second primary current is caused to flow through the second primary coil, to generate magnetomotive force, at the same time. In the discharge control performed by the second control unit, after the second control unit performs the boost control, the second switching element is placed in an open state, and a high voltage is induced at the second end of the second secondary coil, to cause discharge to continuously occur at the gap of the spark plug. The first control unit further performs the boost control in which the first switching element is placed in a closed state again, and the first primary current is caused to flow through the first primary coil, to amplify the magnetic flux generated in the closed magnetic circuit, when the second control unit performs the discharge control.

The fourth invention of the present application is directed to the ignition device of the third invention, wherein the first control unit alternately repeats the discharge control and the boost control a plurality of times after performing the primary energization control. Further, the second control unit performs the boost control each time the first control unit performs the discharge control, and performs the discharge control each time the first control unit performs the boost control.

According to the first to fourth inventions of the present application, the iron cores used in two coil sets are connected to each other, to form one closed magnetic circuit, whereby the entire ignition coil including the iron cores can be miniaturized.

Especially, according to the third invention of the present application, when the discharge control of the first primary coil is performed, the second primary current is caused to flow through the second primary coil, to amplify the magnetic flux generated in the closed magnetic circuit, whereby flames generated around the plug can be maintained for a longer period of time. Further, when the discharge control of the second primary coil is performed, the first primary current is caused to flow through the first primary coil, to amplify the magnetic flux generated in the closed magnetic circuit, whereby flames generated around the plug can be maintained for a longer period of time.

Especially, according to the fourth invention of the present application, flames generated around the plug can be maintained for a much longer period of time.

### BRIEF DESCRIPTION OF THE DRAWINGS

FIG. 1 is a block diagram schematically showing an operating environment of an ignition device for use in an internal combustion engine;

FIG. 2 is a schematic longitudinal sectional view of an ignition coil;

FIG. 3 is a schematic longitudinal sectional view of the ignition coil;

FIG. 4 is graphs showing a waveform of a first EST signal, a waveform of a first primary current, a waveform of a first secondary current, a waveform of a second EST signal, a waveform of a second primary current, a waveform of a second secondary current, and a waveform resulting from adding up waveforms of the first secondary current and the second secondary current, in a time series, in causing the ignition device to operate;

FIG. 5 is an explanatory view schematically showing a direction of a magnetic flux during primary energization control;

FIG. 6 is an explanatory view schematically showing a direction of a magnetic flux during discharge control; and

FIG. 7 is an explanatory view schematically showing a direction of a magnetic flux during discharge control.

### DESCRIPTION OF THE PREFERRED EMBODIMENTS

Below, an illustrative preferred embodiment of the present disclosure will be described with reference to the drawings. Note that components described in the preferred embodiment are mere examples, and are not intended to limit the scope of the present invention to those only. Further, in the drawings, for the purpose of easier understanding, the dimensions or the number of respective components are overstated or understated in some portions of illustration, as necessary.

### 1. First Preferred Embodiment

### <1-1. Configuration of Ignition Device>

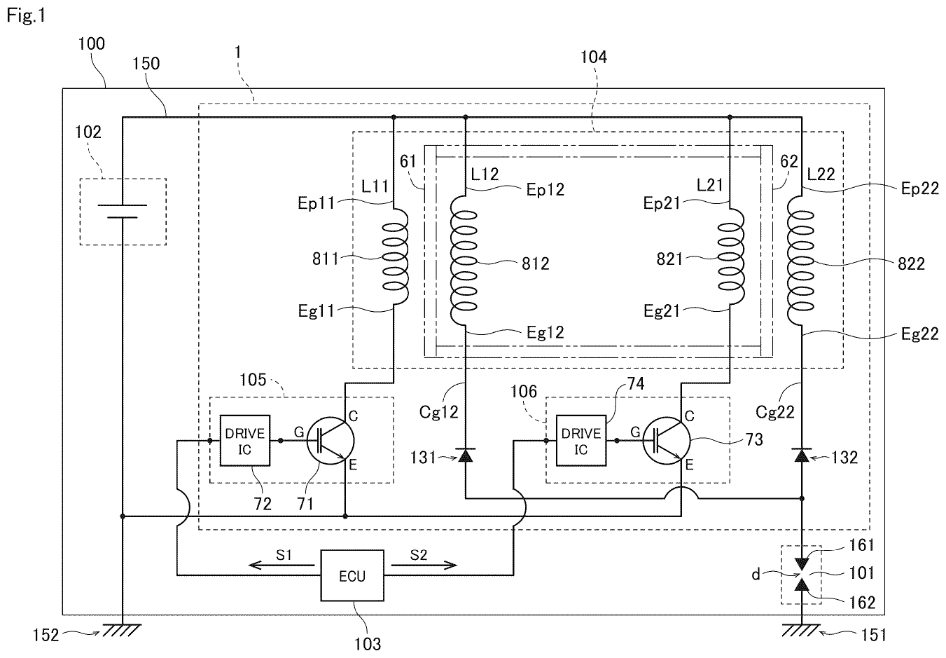

First, a configuration of an ignition device 1 for use in an internal combustion engine corresponding to a first preferred embodiment of the present disclosure will be described with reference to the drawings. FIG. 1 is a block diagram schematically showing an operating environment of the ignition device 1 according to the first preferred embodiment. Note that a first primary coil L11 and a first secondary coil L12 of an ignition coil 104 included in the ignition device 1 are arranged in a direction in which the coils are stacked on each other as described later, but they are shown as being arranged adjacent to each other in FIG. 1 for the purpose of easy understanding. Likewise, a second primary coil L21 and a second secondary coil L22 of the ignition coil 104 are arranged in a direction in which the coils are stacked on each other, but they are shown as being arranged adjacent to each other in FIG. 1 for the purpose of easy understanding.

The ignition device 1 according to the present embodiment is, for example, a device that is mounted in an internal combustion engine such as a spark-ignition (SI) reciprocating engine used in a vehicle body 100 of an automobile or the like and applies a high voltage for causing spark discharge to occur in a spark plug 101. The ignition device 1 is provided in one cylinder or each of a plurality of cylinders included in the internal combustion engine.

Further, as shown in FIG. 1, the vehicle body 100 includes the spark plug 101, a power supply device 102 (battery), and an engine control unit (ECU) 103, in addition to the ignition device 1. Note that, in a broad sense, the spark plug 101, the power supply device 102, and the ECU 103 can be regarded as being included in the ignition device 1.

The spark plug 101 is a device for performing an ignition operation in a combustion chamber of an internal combustion engine. The spark plug 101 is electrically connected to the other end Eg12 of a first secondary coil L12 (a second end of the first secondary coil L12) of an ignition coil 104 described later via a conductor. Hereinafter, the conductor connecting the spark plug 101 and the other end Eg12 of the first secondary coil L12 will be referred to as a “first secondary-side ground wire Cg12”. The spark plug 101 is interposed between the other end Eg12 of the first secondary coil L12 and a ground point (ground) 151. Further, the spark plug 101 is electrically connected to the other end Eg22 of a second secondary coil L22 (a second end of the second secondary coil L22) of the ignition coil 104 described later via a conductor. Hereinafter, the conductor connecting the spark plug 101 and the other end Eg22 of the second secondary coil L22 will be referred to as a “second secondary-side ground wire Cg22”. The spark plug 101 is interposed between the other end Eg22 of the second secondary coil L22 and the ground point (ground) 151. That is, in the ignition device 1, the one common spark plug 101 is provided for a first coil set 40 and a second coil set 50 that will be described later.

A high voltage is induced in the first secondary coil L12 and/or the second secondary coil L22 of the ignition coil 104. Then, when a sum of a high voltage induced at the other end Eg12 of the first secondary coil L12 and a high voltage induced at the other end Eg22 of the second secondary coil L22 exceeds an electrical breakdown voltage at a gap d (refer to FIG. 1) between a center electrode 161 and a ground electrode 162 of the spark plug 101, discharge occurs at the gap d, so that spark is generated. As a result, a fuel supplied to the internal combustion engine is ignited. In other words, the spark plug 101 ignites a fuel by occurrence of discharge at the gap d, in accordance with a high voltage induced at the other end Eg12 of the first secondary coil L12 and/or a high voltage induced at the other end Eg22 of the second secondary coil L22.

In the present embodiment, a flame-retardant material, such as a lean fuel having a fuel ratio lower than the theoretical air-fuel ratio or ammonia containing no carbon, is used as a fuel. However, the fuel used in the ignition device 1 of the present invention is not limited to those.

The power supply device 102 is a direct-current power chargeable/dischargeable power supply device (storage battery). In the present embodiment, the power supply device 102 is electrically connected to each of the first primary coil L11, the first secondary coil L12, the second primary coil L21, and the second secondary coil L22 of the ignition coil 104 described later, via a conductor. Hereinafter, the conductor connecting the power supply device 102 and each of the first primary coil L11, the first secondary coil L12, the second primary coil L21, and the second secondary coil L22 of the ignition coil 104 described later will be referred to as a “power supply line 150”. The power supply device 102 applies a direct-current voltage to each of one end Ep11 of the first primary coil L11 (a first end of the first primary coil L11), one end Ep12 of the first secondary coil L12 (a first end of the first secondary coil L12), one end Ep21 of the second primary coil L21 (a first end of the second primary coil L21), and one end Ep22 of the second secondary coil L22 (a first end of the second secondary coil L22) of the ignition coil 104 via the power supply line 150. Meanwhile, by provision of a first diode 131 and a second diode 132 as described later, a current is prevented from flowing through the first secondary coil L12 and the second secondary coil L22 due to application of a voltage from the power supply device 102.

The ECU 103 is an existing computer that comprehensively controls operations and the like of a transmission and an engine in the vehicle body 100.

The ignition device 1 includes the ignition coil 104, a first igniter 105, a second igniter 106, the first diode 131, and the second diode 132.

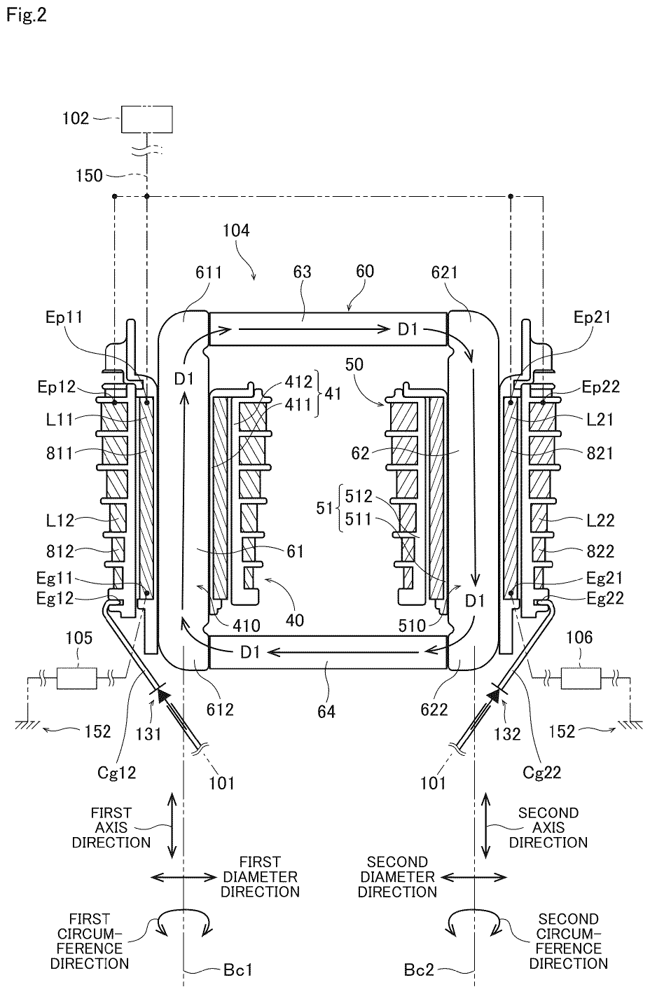

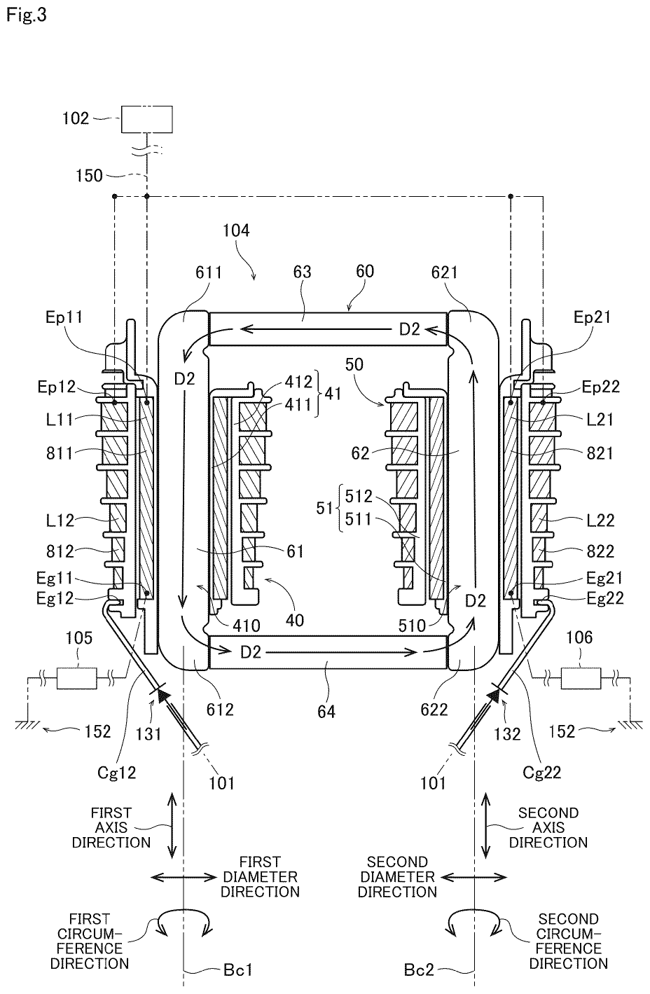

FIG. 2 and FIG. 3 are each a schematic longitudinal sectional view of the ignition coil 104. Note that, in FIG. 2 and FIG. 3, each component such as the power supply device 102 except the ignition coil 104 is shown by a long-dashed double short-dashed line. As shown in FIG. 2 and FIG. 3, the ignition coil 104 includes the first coil set 40, the second coil set 50, and an iron core 60. The first coil set 40 includes a first bobbin 41, the first primary coil L11, and the first secondary coil L12. The second coil set 50 includes a second bobbin 51, the second primary coil L21, and the second secondary coil L22. The ignition coil 104 is incorporated in a coil case (not shown) additionally provided, integrally with the first igniter 105 and the second igniter 106.

Note that, in the following description about the ignition coil 104, a direction parallel with a first center axis Bc1 of the first bobbin 41, a direction perpendicular to the first center axis Bc1, and a direction along an arc having its center on the first center axis Bc1 will be referred to as a “first axis direction”, a “first diameter direction”, and a “first circumference direction”, respectively. Further, a direction parallel with a second center axis Bc2 of the second bobbin 51, a direction perpendicular to the second center axis Bc2, and a direction along an arc having its center on the second center axis Bc2 will be referred to as a “second axis direction”, a “second diameter direction”, and a “second circumference direction”, respectively. Meanwhile, the “direction parallel with something” includes a direction substantially parallel with something, and the “direction perpendicular to something” includes a direction substantially perpendicular to something. Moreover, the first center axis Bc1 and the second center axis Bc2 of the present embodiment are substantially parallel with each other.

The first bobbin 41 includes a first primary bobbin 411 and a first secondary bobbin 412 that can be connected to each other. Each of the first primary bobbin 411 and the first secondary bobbin 412 extends in a tubular shape along the first center axis Bc1. Further, the first secondary bobbin 412 is placed on the outer side of the first primary bobbin 411 with respect to the first diameter direction. For a material of the first primary bobbin 411 and the first secondary bobbin 412, resin is used, for example. The first primary coil L11 is formed by winding of a conductor around an outer surface of the first primary bobbin 411 in the first circumference direction having its center on the first center axis Bc1. Hereinafter, the conductor wound around the outer surface of the first primary bobbin 411 will be referred to as a “first primary winding 811”. That is, the first primary coil L11 includes the first primary winding 811.

After the first primary coil L11 is formed, the first secondary bobbin 412 is placed so as to cover the outer surface of the first primary coil L11, and is connected to the first primary bobbin 411. Then, a conductor different from the first primary winding 811 is wound around the outer surface of the first secondary bobbin 412 in the first circumference direction having its center on the first center axis Bc1, to thereby form the first secondary coil L12. Hereinafter, the different conductor wound around the outer surface of the first secondary bobbin 412 will be referred to as a “first secondary winding 812”. That is, the first secondary coil L12 includes the first secondary winding 812. Thus, by arranging the first primary coil L11 and the first secondary coil L12 such that the coils are stacked on each other, it is possible to further miniaturize the entire ignition coil 104 including those coils. However, the arrangement of the first primary coil L11 and the first secondary coil L12 is not limited to the above-described case in which the coils are stacked on each other. Alternatively, for example, the first primary coil L11 and the first secondary coil L12 may be arranged adjacent to each other along the first axis direction.

The second bobbin 51 includes a second primary bobbin 511 and a second secondary bobbin 512 that can be connected to each other. Each of the second primary bobbin 511 and the second secondary bobbin 512 extends in a tubular shape along the second center axis Bc2. Further, the second secondary bobbin 512 is placed on the outer side of the second primary bobbin 511 with respect to the second diameter direction. For a material of the second primary bobbin 511 and the second secondary bobbin 512, resin is used, for example. The second primary coil L21 is formed by winding of a conductor around an outer surface of the second primary bobbin 511 in the second circumference direction having its center on the second center axis Bc2. Hereinafter, the conductor wound around the outer surface of the second primary bobbin 511 will be referred to as a “second primary winding 821”. That is, the second primary coil L21 includes the second primary winding 821.

After the second primary coil L21 is formed, the second secondary bobbin 512 is placed so as to cover the outer surface of the second primary coil L21, and is connected to the second primary bobbin 511. Then, a conductor different from the second primary winding 821 is wound around the outer surface of the second secondary bobbin 512 in the second circumference direction having its center on the second center axis Bc2, to thereby form the second secondary coil L22. Hereinafter, the different conductor wound around the outer surface of the second secondary bobbin 512 will be referred to as a “second secondary winding 822”. That is, the second secondary coil L22 includes the second secondary winding 822. Thus, by arranging the second primary coil L21 and the second secondary coil L22 such that the coils are stacked on each other, it is possible to further miniaturize the entire ignition coil 104 including those coils. However, the arrangement of the second primary coil L21 and the second secondary coil L22 is not limited to the above-described case in which the coils are stacked on each other. Alternatively, for example, the second primary coil L21 and the second secondary coil L22 may be arranged adjacent to each other along the second axis direction.

The iron core 60 has a structure in which a first iron core 61, a second iron core 62, a one-end connecting iron core 63, and an other-end connecting iron core 64 are combined. Each of the first iron core 61, the second iron core 62, the one-end connecting iron core 63, and the other-end connecting iron core 64 of the iron core 60 is formed of a laminated steel sheet in which silicon steel sheets are stuck together, for example. The first iron core 61 extends in a columnar shape along the first center axis Bc1. The first iron core 61 is inserted through a space 410 on an inner side with respect to the first diameter direction in the first primary bobbin 411. In other words, the first iron core 61 passes through the inside of the first primary coil L11 and the inside of the first secondary coil L12. Meanwhile, the second iron core 62 extends in a columnar shape along the second center axis Bc2. The second iron core 62 is inserted through a space 510 on an inner side with respect to the second diameter direction in the second primary bobbin 511. In other words, the second iron core 62 passes through the inside of the second primary coil L21 and the inside of the second secondary coil L22.

Each of the one-end connecting iron core 63 and the other-end connecting iron core 64 of the present embodiment extends in a columnar shape along a direction substantially perpendicular to the first center axis Bc1 and the second center axis Bc2. The one-end connecting iron core 63 connects one end 611 of the first iron core 61 with respect to the first axis direction and one end 621 of the second iron core 62 with respect to the second axis direction. In other words, the one end 611 of the first iron core 61 and the one end 621 of the second iron core 62 are connected via the one-end connecting iron core 63. Meanwhile, the other-end connecting iron core 64 connects the other end 612 of the first iron core 61 with respect to the first axis direction and the other end 622 of the second iron core 62 with respect to the second axis direction. In other words, the other end 612 of the first iron core 61 and the other end 622 of the second iron core 62 are connected via the other-end connecting iron core 64.

Thus, one ring-shaped closed magnetic circuit in which the first iron core 61, the one-end connecting iron core 63, the second iron core 62, and the other-end connecting iron core 64 are connected in the stated order is formed. Further, the first iron core 61 electromagnetically couples the first primary coil L11 and the first secondary coil L12 to each other. Meanwhile, the second iron core 62 electromagnetically couples the second primary coil L21 and the second secondary coil L22 to each other.

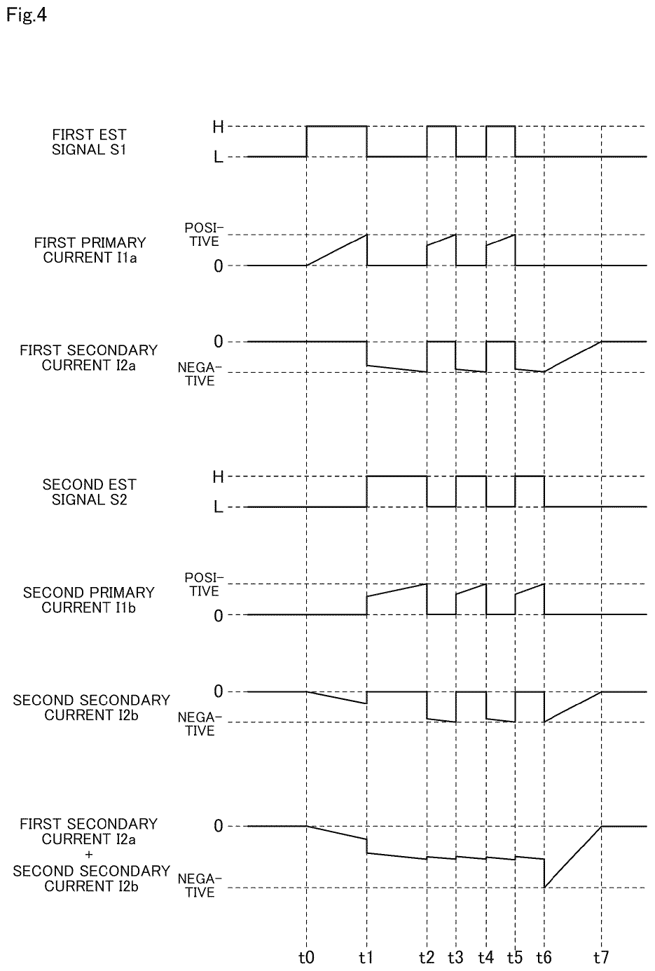

As described above, the one end Ep11 of the first primary coil L11 is connected to the power supply line 150 that is a conductor extending from the power supply device 102. The other end Eg11 of the first primary coil L11 (a second end of the first primary coil L11) is connected to a ground point (ground) 152 via the first igniter 105 described later. Under control of the first igniter 105, a low direct-current voltage from the power supply device 102 is applied to the one end Ep11 of the first primary coil L11, and a first primary current I1a (refer to t0 to t1 in FIG. 4) that gradually increases starts flowing through the first primary coil L11.

Meanwhile, in the present embodiment, the first primary winding 811 is wound clockwise from the one end Ep11 to the other end Eg11 when the first primary coil L11 is viewed from the other end 612 toward the one end 611 of the first iron core 61 passing through the inner side with respect to the first diameter direction in the first primary coil L11. In other words, the first primary winding 811 is wound clockwise from the one end Ep11 to the other end Eg11 when viewed from a lower side toward an upper side in the drawing sheet of FIG. 2. Thus, when a low direct-current voltage from the power supply device 102 is applied to the one end Ep11 of the first primary coil L11, an energization magnetic flux in one direction D1 in FIG. 2 is generated according to the corkscrew rule. In other words, when a direct-current voltage from the power supply device 102 is applied to the first primary coil L11, an energization magnetic flux directed from the other end 612 to the one end 611 is generated in the first iron core 61.

Further, in the present embodiment, the first secondary winding 812 is wound clockwise from the one end Ep12 to the other end Eg12 when the first secondary coil L12 is viewed from the other end 612 toward the one end 611 of the first iron core 61 passing through the inner side with respect to the first diameter direction in the first secondary coil L12. In other words, the first secondary winding 812 is wound clockwise from the one end Ep12 to the other end Eg12 when viewed from a lower side toward an upper side in the drawing sheet of FIG. 2. Moreover, the other end Eg12 of the first secondary coil L12 is connected to the spark plug 101 via the first secondary-side ground wire Cg12. The first secondary winding 812 has a wire diameter smaller than a wire diameter of the first primary winding 811. Further, the number of turns of the first secondary winding 812 in the first secondary coil L12 is about 100 times or more the number of turns of the first primary winding 811 in the first primary coil L11. With this configuration, as described later in detail, the ignition coil 104 steps up low direct-current voltage power supplied from the power supply device 102 to several thousands of volts to several tens of thousands of volts during interruption of the first primary current I1a. That is, a high voltage is induced in the first secondary coil L12. Then, the first secondary coil L12 supplies the induced high-voltage power to the spark plug 101. In this manner, electric spark is generated in the spark plug 101, and a fuel is ignited.

Note that, as shown in FIG. 1, in the first secondary-side ground wire Cg12, the first diode 131 is connected in series to the first secondary coil L12. The first diode 131 is forward-biased from the other end Eg12 to the one end Ep12 of the first secondary coil L12. Thus, an induced current caused by a voltage that is induced in the first secondary coil L12 by the first primary current I1a gradually increasing during energization of the first primary coil L11 is prevented from flowing to the spark plug 101 in a reverse direction. Further, as described above, the one end Ep12 of the first secondary coil L12 is connected to the power supply line 150 that is a conductor extending from the power supply device 102.

Moreover, as described above, the one end Ep21 of the second primary coil L21 is connected to the power supply line 150 that is a conductor extending from the power supply device 102. The other end Eg21 of the second primary coil L21 (a second end of the second primary coil L21) is connected to the ground point (ground) 152 via the second igniter 106 described later. Under control of the second igniter 106, a low direct-current voltage from the power supply device 102 is applied to the one end Ep21 of the second primary coil L21, and a second primary current I1b (refer to t1 to t2 in FIG. 4) that gradually increases starts flowing through the second primary coil L21.

Meanwhile, in the present embodiment, the second primary winding 821 is wound clockwise from the one end Ep21 to the other end Eg21 when the second primary coil L21 is viewed from the other end 622 toward the one end 621 of the second iron core 62 passing through the inner side with respect to the second diameter direction in the second primary coil L21. In other words, the second primary winding 821 is wound clockwise from the one end Ep21 to the other end Eg21 when viewed from a lower side toward an upper side in the drawing sheet of FIG. 2. Thus, when a low direct-current voltage from the power supply device 102 is applied to the one end Ep21 of the second primary coil L21, an energization magnetic flux in another direction D2 in FIG. 3, opposite to the above-described one direction D1, is generated according to the corkscrew rule. In other words, when a direct-current voltage from the power supply device 102 is applied to the second primary coil L21, an energization magnetic flux directed from the other end 622 to the one end 621 is generated in the second iron core 62.

Further, in the present embodiment, the second secondary winding 822 is wound clockwise from the one end Ep22 to the other end Eg22 when the second secondary coil L22 is viewed from the other end 622 toward the one end 621 of the second iron core 62 passing through the inner side with respect to the second diameter direction in the second secondary coil L22. In other words, the second secondary winding 822 is wound clockwise from the one end Ep22 to the other end Eg22 when viewed from a lower side toward an upper side in the drawing sheet of FIG. 2. Moreover, the other end Eg22 of the second secondary coil L22 is connected to the spark plug 101 via the second secondary-side ground wire Cg22. The second secondary winding 822 has a wire diameter smaller than a wire diameter of the second primary winding 821. Further, the number of turns of the second secondary winding 822 in the second secondary coil L22 is about 100 times or more the number of turns of the second primary winding 821 in the second secondary coil L22. Thus, as described later in detail, the ignition coil 104 steps up low direct-current voltage power supplied from the power supply device 102 to several thousands of volts to several tens of thousands of volts during interruption of the second primary current I1b. That is, a high voltage is induced in the second secondary coil L22. Then, the second secondary coil L22 supplies the induced high-voltage power to the spark plug 101. Consequently, electric spark generated in the spark plug 101 can be maintained for a longer period of time.

Note that, as shown in FIG. 1, in the second secondary-side ground wire Cg22, the second diode 132 is connected in series to the second secondary coil L22. The second diode 132 is forward-biased from the other end Eg22 to the one end Ep22 of the second secondary coil L22. Thus, an induced current caused by a voltage that is induced in the second secondary coil L22 by the second primary current I1b gradually increasing during energization of the second primary coil L21 is prevented from flowing to the spark plug 101 in a reverse direction. Further, as described above, the one end Ep22 of the second secondary coil L22 is connected to the power supply line 150 that is a conductor extending from the power supply device 102.

As described above, in the present embodiment, in the ignition coil 104, the first iron core 61 inserted through the inside of the first coil set 40 and the second iron core 62 inserted through the inside of the second coil set 50 are connected to each other, to thereby form one closed magnetic circuit. This enables miniaturization of the entire ignition coil 104 including the iron core 60 as compared to a case in which a closed magnetic circuit is formed for each of the coil sets 40 and 50. Further, the above-described structure of the iron core 60 allows amplification of the magnetic flux generated in the closed magnetic circuit as described later, to thereby increase ignition energy supplied to the spark plug 101. This enables energy enhancement. Consequently, the ignition device 1 including the ignition coil 104 can be more easily mounted in an internal combustion engine. Further, the number of components can be reduced, leading to reduction of a manufacturing cost for the entire device.

The first igniter 105 is a semiconductor device that is connected to the first primary coil L11 and controls a current flowing through the first primary coil L11. Further, the first igniter 105 is electrically connected to the ECU 103 and receives a signal from the ECU 103. Hereinafter, the signal received by the first igniter 105 from the ECU 103 will be referred to as a “first EST signal S1”. The first igniter 105 includes a first switching element 71 and a first drive IC 72. Note that the first igniter 105 may be integral with an electronic circuit of the ECU 103.

For the first switching element 71, for example, an insulated gate bipolar transistor (IGBT) is used. The first switching element 71 is interposed between the other end Eg11 of the first primary coil L11 and the ground point (ground) 152. A collector (C) of the first switching element 71 is connected to the other end Eg11 of the first primary coil L11. An emitter (E) of the first switching element 71 is connected to the ground point (ground) 152. A gate (G) of the first switching element 71 is connected to the first drive IC 72.

This configuration allows the first switching element 71 to perform switching between passage and interruption of the first primary current I1a flowing from the power supply device 102 to the first primary coil L11. When the first switching element 71 is placed in a closed state, the first primary current I1a flows from the power supply device 102 to the first primary coil L11. When the first switching element 71 is placed in an open state, the first primary current I1a flowing through the first primary coil L11 is interrupted. Note that another kind of transistor may be used for the first switching element 71.

The first drive IC 72 controls switching of the first switching element 71 in response to the first EST signal S1 received from the ECU 103. The first drive IC 72 corresponds to a “first control unit” of the present disclosure. The first drive IC 72 includes a logic device connected to the first switching element 71. The logic device includes, for example, a logic circuit, a processor, a complex programmable logic device (CPLD), a field-programmable gate array (FPGA), an application-specific integrated circuit (ASIC), or the like. The logic device performs arithmetic processing for causing the ignition device 1 to operate, to achieve ignition in the spark plug 101.

The second igniter 106 is a semiconductor device that is connected to the second primary coil L21 and controls a current flowing through the second primary coil L21. Further, the second igniter 106 is electrically connected to the ECU 103 and receives a signal from the ECU 103. Hereinafter, the signal received by the second igniter 106 from the ECU 103 will be referred to as a “second EST signal S2”. The second igniter 106 includes a second switching element 73 and a second drive IC 74. Note that the second igniter 106 may be integral with the electronic circuit of the ECU 103.

For the second switching element 73, for example, an insulated gate bipolar transistor (IGBT) is used. The second switching element 73 is interposed between the other end Eg21 of the second primary coil L21 and the ground point (ground) 152. A collector (C) of the second switching element 73 is connected to the other end Eg21 of the second primary coil L21. An emitter (E) of the second switching element 73 is connected to the ground point (ground) 152. A gate (G) of the second switching element 73 is connected to the second drive IC 74.

This configuration allows the second switching element 73 to perform switching between passage and interruption of the second primary current I1b flowing from the power supply device 102 to the second primary coil L21. When the second switching element 73 is placed in a closed state, the second primary current I1b flows from the power supply device 102 to the second primary coil L21. When the second switching element 73 is placed in an open state, the second primary current I1b flowing through the second primary coil L21 is interrupted. Note that another kind of transistor may be used for the second switching element 73.

The second drive IC 74 controls switching of the second switching element 73 in response to the second EST signal S2 received from the ECU 103. The second drive IC 74 corresponds to a “second control unit” of the present disclosure. The second drive IC 74 includes a logic device connected to the second switching element 73. The logic device includes, for example, a logic circuit, a processor, a complex programmable logic device (CPLD), a field-programmable gate array (FPGA), an application-specific integrated circuit (ASIC), or the like. The logic device performs arithmetic processing for causing the ignition device 1 to operate, to achieve ignition in the spark plug 101.

### <1-2. Operations of Ignition Device>

Next, operations of the ignition device 1 will be described. FIG. 4 is graphs respectively showing a waveform of the first EST signal S1, a waveform of the first primary current I1a flowing through the first primary coil L11, a waveform of a first secondary current I2a flowing through the first secondary coil L12, a waveform of the second EST signal S2, a waveform of the second primary current I1b flowing through the second primary coil L21, a waveform of a second secondary current I2b flowing through the second secondary coil L22, and a waveform resulting from adding up a waveform of the first secondary current I2a and a waveform of the second secondary current I2b, in a time series, in causing the ignition device 1 to operate.

Note that, in FIG. 4, regarding the first primary current I1a, a direction from the one end Ep11 to the other end Eg11 of the first primary coil L11 is shown as positive. Meanwhile, regarding the first secondary current I2a, a direction from the other end Eg12 to the one end Ep12 of the first secondary coil L12 is shown as negative. Regarding the second primary current I1b, a direction from the one end Ep21 to the other end Eg21 of the second primary coil L21 is shown as positive. Regarding the second secondary current I2b, a direction from the other end Eg22 to the one end Ep22 of the second secondary coil L22 is shown as negative.

As shown in FIG. 4, in causing the ignition device 1 to operate, first, a signal level of the first EST signal S1 transmitted from the ECU 103 to the first drive IC 72 is changed from L to H at a time to. Then, in response to the first EST signal S1, the first drive IC 72 changes the state of the first switching element 71 from an open state to a closed state. Thus, a low direct-current voltage from the power supply device 102 is applied to the one end Ep11 of the first primary coil L11. Then, the first primary current I1a flows through the first primary winding 811 forming the first primary coil L11, and magnetomotive force is generated in the first primary coil L11. Hereinafter, such a process of causing the first primary current I1a to flow through the first primary coil L11 to generate magnetomotive force will be referred to as “primary energization control”.

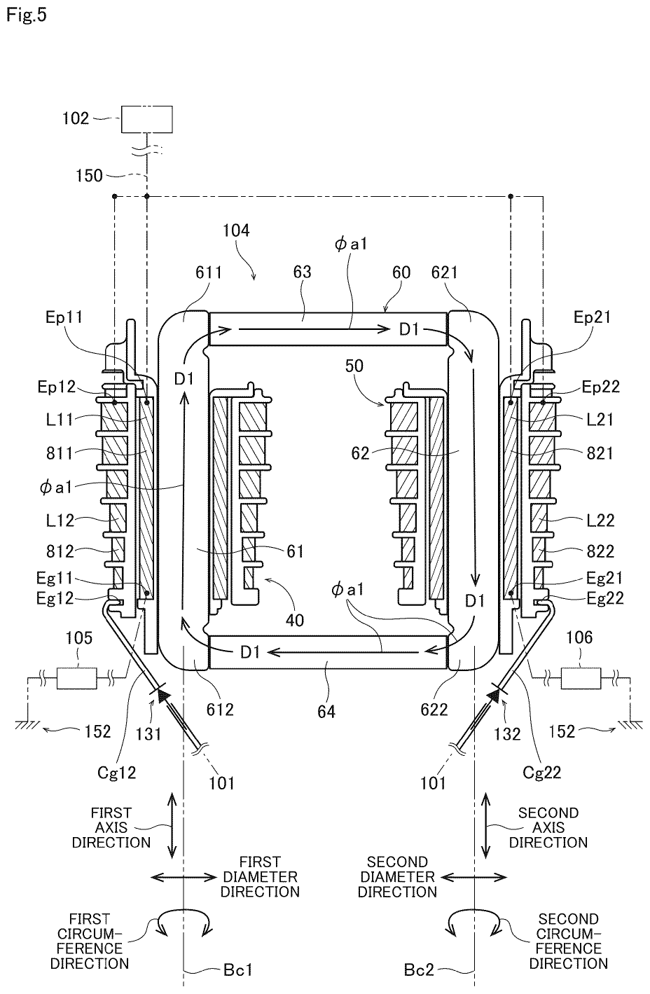

In this regard, as described above, the first primary winding 811 is wound clockwise from the one end Ep11 to the other end Eg11 when viewed from the other end 612 toward the one end 611 of the first iron core 61. Thus, when a low direct-current voltage from the power supply device 102 is applied to the one end Ep11 of the first primary coil L11, an energization magnetic flux ϕa1 in the one direction D1 is generated according to the corkscrew rule. That is, the energization magnetic flux ϕa1 directed in the one direction D1 from the other end 612 to the one end 611 is generated in the first iron core 61, and a magnetic field corresponding to the generated energization magnetic flux ϕa1 acts on the iron core 60 (FIG. 5).

At that time, in each of the first secondary coil L12 electromagnetically coupled to the first primary coil L11 via the iron core 60 and the second secondary coil L22 electromagnetically coupled to the first primary coil L11 via the iron core 60, very small induced electromotive force is caused. In this regard, as described above, the first secondary winding 812 is wound clockwise from the one end Ep12 to the other end Eg12 when viewed from the other end 612 toward the one end 611 of the first iron core 61. Hence, when an induced current (the first secondary current I2a) corresponding to the induced electromotive force attempts to flow, it results in that the induced current (the first secondary current I2a) flows through the first diode 131 connected in series to the first secondary coil L12, in a reverse direction. Thus, the induced current (the first secondary current I2a) is blocked by the first diode 131. As a result, the induced current (the first secondary current I2a) does not flow through the first secondary coil L12 (refer to times t0 to t1 of the first secondary current I2a in FIG. 4).

Meanwhile, the second secondary winding 822 is wound clockwise from the one end Ep22 to the other end Eg22 when viewed from the other end 622 to the one end 621 of the second iron core 62. Hence, when an induced current (the second secondary current I2b) corresponding to the induced electromotive force attempts to flow, it results in that the induced current (the second secondary current I2b) flows through the second diode 132 connected in series to the second secondary coil L22, in a forward direction. Thus, the induced current (the second secondary current I2b) is not blocked by the second diode 132. As a result, the induced current (the second secondary current I2b) flows through the second secondary coil L22 (refer to times t0 to t1 of the second secondary current I2b in FIG. 4). Note that the induced current (the second secondary current I2b) is very weak, and thus no electric spark is generated in the spark plug 101 in principle.

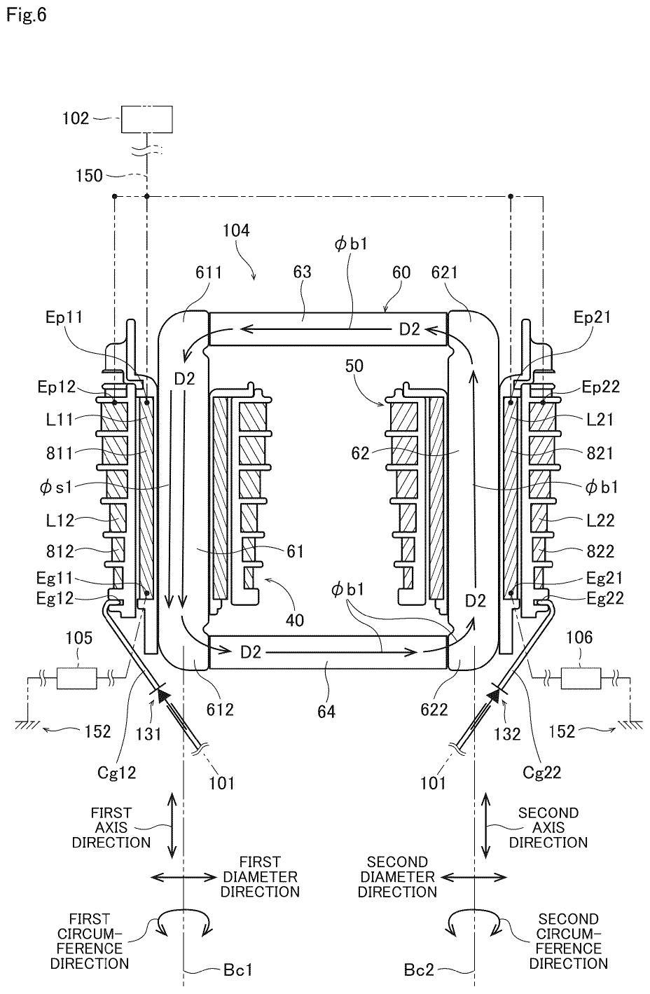

After the primary energization control, at a time t1, the signal level of the first EST signal S1 transmitted from the ECU 103 to the first drive IC 72 is changed from H to L, and at the same time, a signal level of the second EST signal S2 transmitted from the ECU 103 to the second drive IC 74 is changed from L to H. Then, the first drive IC 72 changes the state of the first switching element 71 from a closed state to an open state, to interrupt the primary current (the first primary current I1a) flowing from the power supply device 102 to the first primary coil L11. As a result, an interruption magnetic flux ϕs1 in another direction D2 shown in FIG. 6, opposite to the one direction D1 in which the above-described energization magnetic flux ϕa1 is directed, is generated by the mutual induction effect, and at the same time, large induced electromotive force is caused, in the first secondary coil L12 electromagnetically coupled to the first primary coil L11 via the iron core 60. At that time, a value of a voltage applied to the other end Eg12 of the first secondary coil L12 ranges from minus several thousands of volts to several tens of thousands of volts with respect to the ground point (ground) 152.

In this regard, as described above, the first secondary winding 812 is wound clockwise from the one end Ep12 to the other end Eg12 when viewed from the other end 612 toward the one end 611 of the first iron core 61. Hence, when an induced current (the first secondary current I2a) corresponding to the induced electromotive force attempts to flow, it results in that the induced current (the first secondary current I2a) flows through the first diode 131 connected in series to the first secondary coil L12, in a forward direction. Thus, the induced current (the first secondary current I2a) is not blocked by the first diode 131. As a result, a large induced current (the first secondary current I2a) flows through the first secondary coil L12 (refer to times t1 to t2 of the first secondary current I2a in FIG. 4). Consequently, electric spark can be generated in the spark plug 101 connected to the other end Eg12 of the first secondary coil L12, and a fuel can be ignited. Hereinafter, such a process of inducing a high voltage at the other end Eg12 of the first secondary coil L12 by interrupting the first primary current I1a flowing through the first primary coil L11, to cause discharge to occur at the gap d of the spark plug 101 will be referred to as “discharge control”.

Further, at the same time that the first drive IC 72 starts the above-described discharge control, the second drive IC 74 changes the state of the second switching element 73 from an open state to a closed state. As a result, a low direct-current voltage from the power supply device 102 is applied to the one end Ep21 of the second primary coil L21. Then, the second primary current I1b flows through the second primary winding 821 forming the second primary coil L21, and magnetomotive force is generated in the second primary coil L21. In other words, the second drive IC 74 performs primary energization control in which the second primary current I1b is caused to flow through the second primary coil L21, to generate magnetomotive force. In this regard, as described above, the second primary winding 821 is wound clockwise from the one end Ep21 to the other end Eg21 when viewed from the other end 622 toward the one end 621 of the second iron core 62. Hence, when a low direct-current voltage from the power supply device 102 is applied to the one end Ep21 of the second primary coil L21, an energization magnetic flux ϕb1 in another direction D2 described above is generated according to the corkscrew rule. That is, the energization magnetic flux ϕb1 directed in another direction D2 from the other end 622 to the one end 621 is generated in the second iron core 62, and a magnetic field corresponding to the generated energization magnetic flux ϕb1 acts on the iron core 60 (FIG. 6).

In this regard, as described above, in the iron core 60 of the present disclosure, only one ring-shaped closed magnetic circuit in which the first iron core 61, the one-end connecting iron core 63, the second iron core 62, and the other-end connecting iron core 64 are connected in the stated order is formed. Then, the interruption magnetic flux ϕs1 generated during the above-described discharge control by the first drive IC 72 and the energization magnetic flux ϕb1 generated by energization of the second primary coil L21 are directed in the same direction, i.e., another direction D2, in the closed magnetic circuit. Hence, when the second primary coil L21 is energized under control of the second drive IC 74 during the discharge control by the first drive IC 72, the magnetic flux generated in the closed magnetic circuit of the iron core 60 is amplified. Hereinafter, such a process in which the second drive IC 74 places the second switching element 73 in a closed state, to cause the second primary current I1b to flow through the second primary coil L21 and amplify a magnetic flux generated in the closed magnetic circuit of the iron core 60 when the first drive IC 72 performs the discharge control will be referred to as a “boost control”. That is, when the second drive IC 74 performs the boots control, the second drive IC 74 also performs primary energization control in which the second primary current I1b is caused to flow through the second primary coil L21, to generate magnetomotive force, at the same time.

As described above, when the discharge control of the first primary coil L11 is performed, the second primary current I1b is caused to flow through the second primary coil L21, to amplify the magnetic flux generated in the closed magnetic circuit of the iron core 60, whereby a current and ignition energy supplied to the spark plug 101 can be increased (refer to times t1 to t2 of the first secondary current I2a in FIG. 4). Consequently, even in a case in which a flame-retardant fuel such as a lean fuel or ammonia is burned, flames generated around the spark plug 101 can be maintained for a longer period of time.

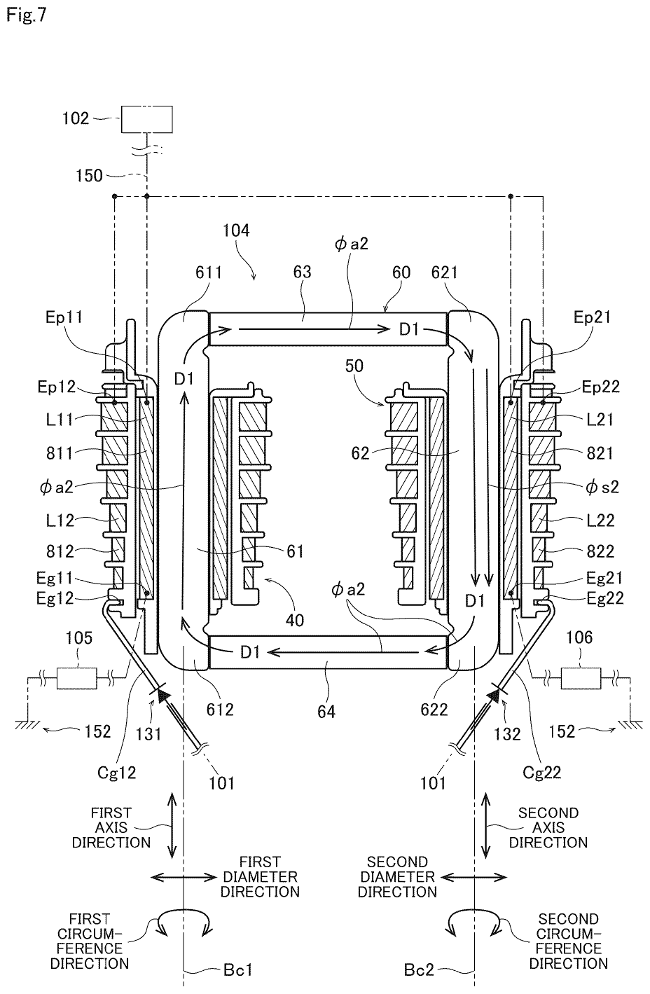

Further, after the second drive IC 74 performs the boost control, at a time t2, the signal level of the second EST signal S2 transmitted from the ECU 103 to the second drive IC 74 is changed from H to L, and at the same time, the signal level of the first EST signal S1 transmitted from the ECU 103 to the first drive IC 72 is changed from L to H. Then, the second drive IC 74 changes the state of the second switching element 73 from a closed state to an open state, to interrupt the primary current (the second primary current I1b) flowing from the power supply device 102 to the second primary coil L21. As a result, an interruption magnetic flux Øs2 in the one direction D1 shown in FIG. 7, opposite to another direction D2 in which the energization magnetic flux ϕb1 in FIG. 6 is directed, is generated by the mutual induction effect, and at the same time, large induced electromotive force is caused, in the second secondary coil L22 electromagnetically coupled to the second primary coil L21 via the iron core 60. At that time, a value of a voltage applied to the other end Eg22 of the second secondary coil L22 ranges from minus several thousands of volts to several tens of thousands of volts with respect to the ground point (ground) 152.

In this regard, as described above, the second secondary winding 822 is wound clockwise from the one end Ep22 to the other end Eg22 when viewed from the other end 622 toward the one end 621 of the second iron core 62. Thus, when an induced current (the second secondary current I2b) corresponding to the induced electromotive force attempts to flow, it results in that the induced current (the second secondary current I2b) flows through the second diode 132 connected in series to the second secondary coil L22, in a forward direction. Hence, the induced current (the second secondary current I2b) is not blocked by the second diode 132. As a result, the large induced current (the second secondary current I2b) flows through the second secondary coil L22 (refer to times t2 to t3 of the second secondary current I2b in FIG. 4). Consequently, flames generated around the spark plug 101 connected to the other end Eg22 of the second secondary coil L22 can be maintained for a longer period of time. That is, the second drive IC 74, after performing the boost control, places the second switching element 73 in an open state, to induce a high voltage at the other end Eg22 of the second secondary coil L22 at the time t2, and thus, performs discharge control in which discharge is caused to continuously occur at the gap d of the spark plug 101.

Meanwhile, at the same time that the second drive IC 74 starts the above-described discharge control, the first drive IC 72 changes the state of the first switching element 71 from an open state to a closed state at the time t2. As a result, a low direct-current voltage from the power supply device 102 is applied to the one end Ep11 of the first primary coil L11. Then, the first primary current I1a flows through the first primary winding 811 forming the first primary coil L11, and magnetomotive force is generated in the first primary coil L11. In this regard, as described above, the first primary winding 811 is wound clockwise from the one end Ep11 to the other end Eg11 when viewed from the other end 612 toward the one end 611 of the first iron core 61. Thus, when a low direct-current voltage from the power supply device 102 is applied to the one end Ep11 of the first primary coil L11, an energization magnetic flux pa2 in the one direction D1 is generated according to the corkscrew rule. That is, the energization magnetic flux da2 directed in the one direction D1 from the other end 612 to the one end 611 is generated in the first iron core 61, and a magnetic field corresponding to the energization magnetic flux pa2 acts on the iron core 60 (FIG. 7).

The above-described interruption magnetic flux os2 and the energization magnetic flux pa2 are directed in the same direction, i.e., the one direction D1, in the closed magnetic circuit formed in the iron core 60. Hence, when the first primary coil L11 is energized under control of the first drive IC 72 during the discharge control by the second drive IC 74, the magnetic flux generated in the closed magnetic circuit of the iron core 60 is amplified. Thus, in the present embodiment, when the second drive IC 74 performs the discharge control, the first drive IC 72 places the first switching element 71 in a closed state again, to further perform boost control in which the first primary current I1a is caused to flow through the first primary coil L11, to amplify the magnetic flux generated in the closed magnetic circuit of the iron core 60. This can increase a current and ignition energy supplied to the spark plug 101 (refer to times t2 to t3 of the second secondary current I2b in FIG. 4). Consequently, even in a case in which a flame-retardant fuel such as a lean fuel or ammonia is burned, flames generated around the spark plug 101 can be maintained for a longer period of time.

Further, in the present embodiment, at a time t3, the signal level of the first EST signal S1 transmitted from the ECU 103 to the first drive IC 72 is changed from H to L, and at the same time, the signal level of the second EST signal S2 transmitted from the ECU 103 to the second drive IC 74 is changed from L to H. Moreover, at a time t4, the signal level of the second EST signal S2 transmitted from the ECU 103 to the second drive IC 74 is changed from H to L, and at the same time, the signal level of the first EST signal S1 transmitted from the ECU 103 to the first drive IC 72 is changed from L to H. Furthermore, at a time t5, the signal level of the first EST signal S1 transmitted from the ECU 103 to the first drive IC 72 is changed from H to L, and at the same time, the signal level of the second EST signal S2 transmitted from the ECU 103 to the second drive IC 74 is changed from L to H. In addition, at a time t6, the signal level of the second EST signal S2 transmitted from the ECU 103 to the second drive IC 74 is changed from H to L.

As described above, in the present embodiment, the first drive IC 72 performs the discharge control after performing the above-described primary energization control, and then alternately repeats the boost control and the discharge control a plurality of times. That is, the first drive IC 72 alternately repeats the discharge control and the boost control a plurality of times after performing the primary energization control. Then, when the first drive IC 72 performs the discharge control for the first time, the second drive IC 74 simultaneously performs the boots control and the primary energization control. After that, the second drive IC 74 alternately repeats the discharge control and the boost control a plurality of times, synchronously with a change in control by the first drive IC 72. Specifically, the second drive IC 74 performs the above-described boost control each time the first drive IC 72 performs the discharge control, and performs the above-described discharge control each time the first drive IC 72 performs the boost control. In this control manner, even in a case in which a flame-retardant fuel such as a lean fuel or ammonia is burned, flames generated around the spark plug 101 can be maintained for a much longer period of time. Note that the number of times the first drive IC 72 and the second drive IC 74 change each control can be appropriately determined.

### 2. Modifications

The illustrative preferred embodiment of the present disclosure has been described above, but the present invention is not limited to the above-described preferred embodiment.

In the above-described preferred embodiment, a low direct-current voltage from the power supply device 102 is applied to one end of each coil, and the other end of each coil is connected to the ground point. Further, the winding forming each coil is wound clockwise from the one end to the other end when viewed from the other end toward the one end of the iron core passing through the inside of each coil. Alternatively, a low direct-current voltage from the power supply device 102 may be applied to the other end of each coil, and one end of each coil may be connected to the ground point. In this case, the winding forming each coil is only required to be wound counterclockwise from one end to the other end when viewed from the other end toward the one end of the iron core passing through the inside of each coil.

The ignition coil and the ignition device according to the present disclosure can be applied to any device that is mounted in various apparatuses such as a power generator or industrial machines, in addition to a vehicle such as an automobile, and is used for generating electric spark in a spark plug of an internal combustion engine, to ignite a fuel.

The details of the shapes and configurations of the ignition coil and the ignition device described above may be appropriately changed within a scope not departing from the gist of the present disclosure. Further, the respective elements described in the above-described preferred embodiment and modifications may be appropriately combined unless contradiction arises.

What is claimed is:

1. An ignition coil for use in an internal combustion engine, comprising:
a first primary coil including a first primary winding, in which a direct-current voltage is applied to a first end and a second end is connected to a ground point;
a first secondary coil including a first secondary winding;
a first iron core that passes through an inside of the first primary coil and an inside of the first secondary coil and is configured to electromagnetically couple the first primary coil and the first secondary coil;
a second primary coil including a second primary winding, in which the direct-current voltage is applied to a first end and a second end is connected to the ground point;
a second secondary coil including a second secondary winding; and
a second iron core that passes through an inside of the second primary coil and an inside of the second secondary coil and is configured to electromagnetically couple the second primary coil and the second secondary coil, wherein
one end of the first iron core and one end of the second iron core are connected to each other, and the other end of the first iron core and the other end of the second iron core are connected to each other, to form a closed magnetic circuit,
a magnetic flux directed from the other end to the one end is generated in the first iron core when the direct-current voltage is applied to the first primary coil, and
a magnetic flux directed from the other end to the one end is generated in the second iron core when the direct-current voltage is applied to the second primary coil.

2. An ignition device comprising:
the ignition coil according to claim 1;
a power supply device configured to apply the direct-current voltage to each of the first end of the first primary coil and the first end of the second primary coil;
a first switching element that is interposed between the second end of the first primary coil and the ground point and is configured to perform switching between passage and interruption of a first primary current flowing from the power supply device to the first primary coil;
a second switching element that is interposed between the second end of the second primary coil and the ground point and is configured to perform switching between passage and interruption of a second primary current flowing from the power supply device to the second primary coil;
a first control unit configured to control the switching of the first switching element;
a second control unit configured to control the switching of the second switching element; and
a spark plug configured to ignite a fuel by occurrence of discharge at a gap, in accordance with a high voltage induced at a second end of the first secondary coil and/or a high voltage induced at a second end of the second secondary coil.

3. The ignition device according to claim 2, wherein
the first control unit performs primary energization control in which the first switching element is placed in a closed state and the first primary current is caused to flow through the first primary coil, to generate magnetomotive force, and after the primary energization control, performs discharge control in which the first switching element is placed in an open state and a high voltage is induced at the second end of the first secondary coil, to cause discharge to occur at the gap of the spark plug,
the second control unit performs boost control in which the second switching element is placed in a closed state and the second primary current is caused to flow through the second primary coil, to amplify the magnetic flux generated in the closed magnetic circuit, when the first control unit performs the discharge control, and after the boost control, performs discharge control in which the second switching element is placed in an open state and a high voltage is induced at the second end of the second secondary coil, to cause discharge to continuously occur at the gap of the spark plug, and
the first control unit further performs boost control in which the first switching element is placed in a closed state and the first primary current is caused to flow through the first primary coil, to amplify the magnetic flux generated in the closed magnetic circuit, when the second control unit performs the discharge control.

4. The ignition device according to claim 3, wherein
the first control unit alternately repeats the discharge control and the boost control a plurality of times after performing the primary energization control, and
the second control unit performs the boost control each time the first control unit performs the discharge control, and performs the discharge control each time the first control unit performs the boost control.
